(19) United States
(12) Patent Application Publication
(10) Pub. No.: US 2012/0206034 A1
(43) Pub. Date: Aug. 16, 2012

(54) RED PHOSPHOR MATERIAL AND PLASMA DISPLAY PANEL

(75) Inventors: Izumi TOYODA, Osaka (JP); Yoshihisa Nagasaki, Osaka (JP); Kazuhiko Sigimoto, Osaka (JP); Yusaku Nishikawa, Osaka (JP)

(73) Assignees: PANASONIC CORPORATION, Osaka City (JP); PANASONIC CORPORATION, Osaka (JP)

(21) Appl. No.: 13/444,420

(22) Filed: Apr. 11, 2012

Related U.S. Application Data
(63) Continuation-in-part of application No. PCT/JP2011/005758, filed on Oct. 14, 2011.

(30) Foreign Application Priority Data
Oct. 15, 2010 (JP) 2010-232183
Feb. 7, 2011 (JP) 2011-023616
Apr. 26, 2011 (JP) 2011-097798

(51) Int. Cl. H01J 61/44; B32B 9/04; C09K 11/83

(52) U.S. Cl. 313/486; 252/301.4 P; 428/446; 428/690

(57) ABSTRACT

The instant application describes a red phosphor material including Y(Pₓ, V₁₋ₓ)O₄:Eu, wherein a value of x is equal to or greater than 0.3 and equal to or less than 0.8.

### TECHNICAL FIELD

The instant application relates to a red phosphor material and a plasma display panel.

### BACKGROUND

In recent years, a plasma display panel (hereinafter, referred to as a PDP) has been applied to a three-dimensional (3-D) image display apparatus which is combined with liquid crystal shutter glasses, and the like.

In order to suppress occurrence of crosstalk in which an image is seen in double from a response time of the liquid crystal shutter glasses in a three-dimensional image display apparatus, the afterglow time of the phosphor material should equal to or less than 4.0 msec. Here, the afterglow time may refer to the time until emission luminance of the phosphor material is attenuated to 1/10.

### SUMMARY

In one general aspect, the instant application describes a red phosphor material including Y(Pₓ, V₁₋ₓ)O₄:Eu, wherein a value of x is equal to or greater than 0.3 and equal to or less than 0.8.

The above general aspect may include one or more of the following features. For example, the value of x may be equal to or greater than 0.3 and equal to or less than 0.6. Alternatively, the value of x may be equal to or greater than 0.6 and equal to or less than 0.8. A surface of Y(Pₓ, V₁₋ₓ)O₄:Eu may be coated with at least one metal oxide selected from the group consisting of magnesium oxide, zinc oxide, and silicon dioxide, and a weight % concentration of the metal oxide with respect to Y(Pₓ, V₁₋ₓ)O₄:Eu may be greater than 0 wt % and less than 5 wt %.

In another general aspect, the instant application describes a plasma display panel including a red phosphor layer, where the red phosphor layer is formed of red phosphor material including Y(Pₓ, V₁₋ₓ)O₄:Eu, where a value of x is equal to or greater than 0.3 and equal to or less than 0.8.

In another general aspect, the instant application describes a plasma display panel including a red phosphor layer, where the red phosphor layer is formed of red phosphor material including Y(Pₓ, V₁₋ₓ)O₄:Eu, where a value of x is equal to or greater than 0.3 and equal to or less than 0.6 or the value of x is equal to or greater than 0.6 and equal to or less than 0.8.

In another general aspect, the instant application describes a plasma display panel including a red phosphor layer, where the red phosphor layer is formed of red phosphor material including Y(Pₓ, V₁₋ₓ)O₄:Eu, where a value of x is equal to or greater than 0.3 and equal to or less than 0.8. A surface of Y(Pₓ, V₁₋ₓ)O₄:Eu is coated with at least one metal oxide selected from the group consisting of magnesium oxide, zinc oxide, and silicon dioxide, and a weight % concentration of the metal oxide with respect to Y(Pₓ, V₁₋ₓ)O₄:Eu is greater than 0 wt % and less than 5 wt %.

### BRIEF DESCRIPTION OF THE DRAWINGS

FIG. 1 is a partial cross-sectional perspective view showing a configuration of PDP of the instant application;

FIG. 2 is a schematic view showing a configuration of a plasma display apparatus of the instant application;

FIG. 3 is a schematic cross-sectional view showing a configuration of a rear plate of a PDP;

FIG. 4 is a view showing the relationship between a value of x of YPV and an afterglow time of a plasma display apparatus;

FIG. 5 is a view showing the relationship between powder luminance and a process maintenance rate with respect to a value of x of YPV;

FIG. 6 is a view showing the relationship between a value of x of YPV and panel luminance;

FIG. 7 is a view showing the relationship between a coated amount of MgO of YPV and panel luminance;

FIG. 8 is a view showing the relationship between a coated amount of ZnO of YPV and panel luminance; and

FIG. 9 is a view showing the relationship between relative luminance and a luminance degradation rate with respect to a coated amount of SiO₂ of YPV.

### DETAILED DESCRIPTION

Hereinafter, exemplary implementations will be described with reference to drawings.

### First Implementation

1. Configuration of Plasma Display Panel

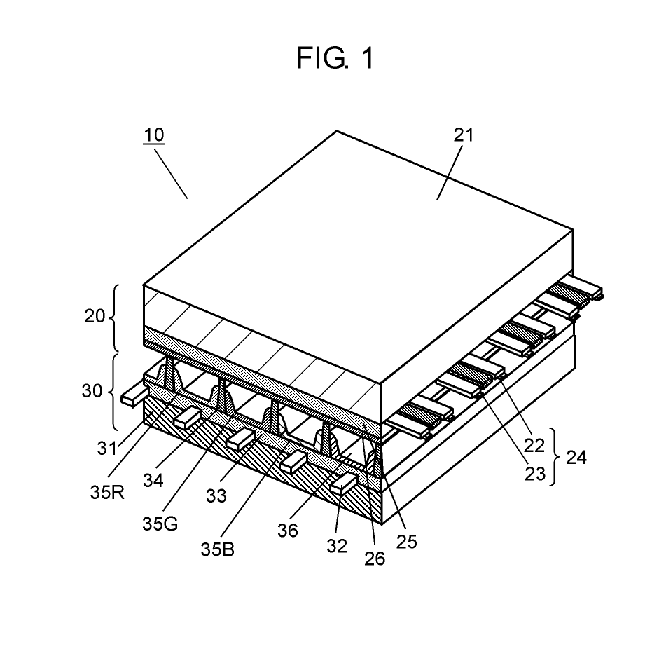

FIG. 1 is a partial cross-sectional perspective view showing a configuration of PDP 10 of the instant application. PDP 10 includes front plate 20 and rear plate 30. Front plate 20 includes front glass substrate 21. On front glass substrate 21, a plurality of display electrode pairs 24 composed of scanning electrodes 22 and sustaining electrodes 23 arranged in parallel is formed. Dielectric layer 25 is formed so as to cover scanning electrode 22 and sustaining electrode 23. Protective layer 26 is formed on dielectric layer 25.

Rear plate 30 includes rear glass substrate 31. On rear glass substrate 31, plurality of address electrodes 32 arranged in parallel is formed. Foundation dielectric layer 33 is formed so as to cover address electrodes 32. Partition 34 is formed on foundation dielectric layer 33. On side surface of partition 34 and on foundation dielectric layer 33, red phosphor layer 35R emitting light in a red color, green phosphor layer 35G emitting light in a green color, and blue phosphor layer 35B emitting light in a blue color are provided. Red phosphor layer 35R, green phosphor layer 35G, and blue phosphor layer 35B are sequentially formed with respect to address electrodes 32.

Front plate 20 and rear plate 30 are disposed to face each other so that display electrode pairs 24 and address electrodes 32 cross each other with a minute discharge space held therebetween. An outer peripheral portion of front plate 20 and rear plate 30 is sealed by a sealing member such as a glass frit, and the like. In the discharge space, a mixed gas of, for example, neon (Ne), xenon (Xe), and the like is sealed at a pressure of 55 kPa to 89 kPa as a discharge gas. The discharge space is partitioned into a plurality of sections by partition 34, so that discharge cell 36 is formed in a portion where display electrode pairs 24 and address electrodes 32 cross each other.

When a discharge voltage is applied between the above described electrodes, discharge occurs within discharge cell 36. A phosphor included in each of red phosphor layer 35R, green phosphor layer 35G, and blue phosphor layer 35B is exited by ultraviolet rays generated by discharge to thereby emit light. Due to this, a color image is displayed on PDP 10. Further, a structure of PDP 10 is not limited to the described above. For example, a structure of partition 34 may be a structure including a partition formed in a parallel cross shape.

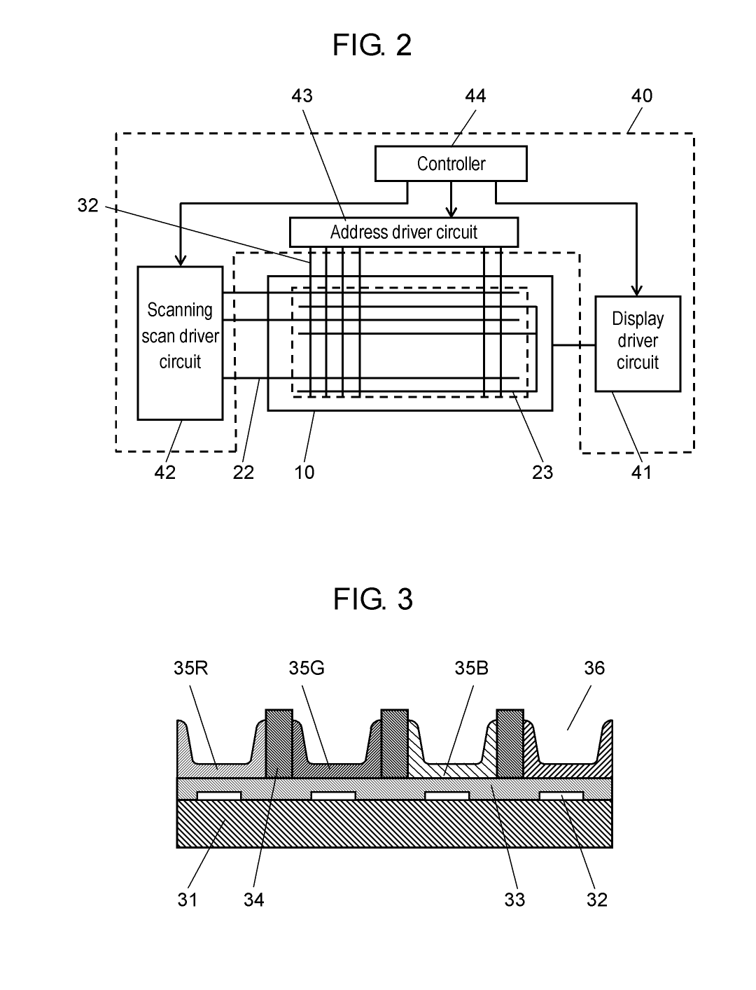

FIG. 2 is a schematic view showing a configuration of a plasma display apparatus of the instant application. The plasma display apparatus includes driving circuit 40 that is connected with PDP 10. Driving circuit 40 is a circuit that displays a color image on PDP 10 by driving PDP 10. Driving circuit 40 includes display driver circuit 41, scanning scan driver circuit 42, address driver circuit 43, and controller 44. Display driver circuit 41 is connected to sustaining electrode 23. Scanning scan driver circuit 42 is connected to scanning electrode 22. Address driver circuit 43 is connected to address electrode 32. Controller 44 is connected to display driver circuit 41, scanning scan driver circuit 42, and address driver circuit 43. Controller 44 controls a driving voltage applied to each of the electrodes by controlling these circuits.

Next, an operation of discharge in PDP 10 will be described. First, a predetermined voltage is applied to scanning electrode 22 and address electrode 32 each corresponding to discharge cell 36 to be turned on. Then, address discharge occurs between scanning electrode 22 and address electrode 32. Due to this, wall charge is formed on discharge cell 36 corresponding to display data. Thereafter, a sustain discharge voltage is applied between sustaining electrode 23 and scanning electrode 22. Then, sustain discharge occurs in discharge cell 36 in which the wall charge is formed, and ultraviolet rays are generated. The phosphor of red phosphor layer 35R, green phosphor layer 35G, and blue phosphor layer 35B is excited by the ultraviolet rays. The excited phosphor is emitted, so that discharge cell 36 is turned on. An image is displayed by a combination each color of discharge cell 36 being turned on and turned off.

2. Manufacturing Method of Plasma Display Panel

Next, a manufacturing method of PDP 10 according to the first implementation will be described. First, a manufacturing method of front plate 20 will be described. On front glass substrate 21, display electrode pairs 24 composed of scanning electrodes 22 and sustaining electrodes 23 are formed. In this instance, a black stripe may be formed between scanning electrode 22 and sustaining electrode 23.

Scanning electrode 22 and sustaining electrode 23 include a transparent electrode such as ITO and a bus electrode containing Ag formed on the transparent electrode, a glass frit, and the like. An ITO thin film is formed on front glass substrate 21 by a sputtering method, and the transparent electrode is formed in a predetermined pattern by a lithography method. In addition, the bus electrode of a predetermined pattern is formed by the lithography method. The black stripe is formed of a material containing a black pigment. Dielectric layer 25 is formed so as to cover scanning electrode 22 and sustaining electrode 23 by a die coating method. Protective layer 26 is formed on dielectric layer 25 by a vacuum deposition method. Next, a manufacturing method of rear plate 30 will be described.

FIG. 3 is a schematic cross-sectional view showing a configuration of rear plate 30 of PDP 10 according to the first implementation. On rear glass substrate 31, a silver paste for electrodes is screen printed. The paste is baked, so that a plurality of address electrodes 32 is formed in a stripe shape. In order to cover address electrode 32, a paste containing a glass material is coated in a die coating method or a screen printing method. The paste is baked, so that foundation dielectric layer 33 is formed.

Partition 34 is formed on foundation dielectric layer 33. As a method of forming partition 34, a method in which the paste containing the glass material is repeatedly coated and baked in a strip shape by the screen printing method while sandwiching address electrode 32 is used. In addition, a method in which the paste is coated and patterned on foundation dielectric layer 33 by coating address electrode 32 to thereby be baked is also used.

The discharge space is partitioned by partition 34, so that discharge cell 36 is formed. A gap of partition 34 is set as being 130 μm to 240 μm, for example, in a full HD television of 42 to 50 inches or an HD television. On a groove between adjacent two partitions 34, the paste containing particles of the phosphor materials emitting light in each color is coated by the screen printing method, an ink jet method, or the like. The paste is baked, so that red phosphor layer 35R, green phosphor layer 35G, and blue phosphor layer 35B are formed. In addition, the phosphor materials used in each of red phosphor layer 35R, green phosphor layer 35G, and blue phosphor layer 35B will be described later.

The rear plate 30 and the front plate 20 manufactured as above are sealed. In this instance, rear plate 30 and front plate 20 are superimposed so that display electrode pairs 24 and address electrode 32 are perpendicular to each other. A sealing glass is coated on an outer peripheral portion of rear plate 30 and front plate 20. The sealing glass seals rear plate 30 and front plate 20. Thereafter, a mixed gas of neon (Ne), xenon (Xe), and the like is sealed at a pressure of 55 kPa to 80 kPa after the discharge space is exhausted to a high vacuum.

In this way, PDP 10 according to the first implementation is manufactured. The manufactured PDP 10 is connected to driving circuit 40. In addition, a plasma display apparatus is assembled into a case, and the like to thereby be prepared.

In this manner, PDP 10 according to the first implementation is applied to a three-dimensional image display apparatus.

3. Overview of Phosphor Material

Next, the phosphor material of each color used in PDP 10 will be described. The phosphor material may be prepared using a solid phase reaction method, a liquid phase method, or a liquid spraying method. The solid phase reaction method is a method in which the phosphor material is prepared by baking oxide or carboxide raw materials and flux. The liquid phase method is a method in which the phosphor material is prepared in a manner such that organic metal salts and nitrate are hydrolyzed in an aqueous solution, and a precursor of the phosphor material that is precipitated to be generated by adding alkali and the like is subjected to heat treatment, if necessary. The liquid spraying method is a method in which the phosphor material is prepared by spraying, into a heated furnace, an aqueous solution containing a raw material of the phosphor material. In the first implementation, the phosphor material is manufactured by the solid phase reaction method.

3-1. Blue Phosphor Material and, Manufacturing Method of the Same

In the first implementation, for example, BaMgAl₁₀O₁₇:Eu having a short afterglow time is used as the blue phosphor material used in the blue phosphor layer 35B. BaMgAl₁₀O₁₇:Eu is prepared by the following method. Barium carbonate (BaCO₃), magnesium carbonate (MgCO₃), aluminum oxide (Al₂O₃), and europium oxide (Eu₂O₃) are mixed to match a combination of a desired phosphor material. The mixture is baked at 800° C. to 1,200° C. in the air. Thereafter, the mixture is baked at 1,200° C. to 1,400° C. in a mixed gas atmosphere containing hydrogen and nitrogen. Accordingly, the blue phosphor material is prepared.

3-2. Green Phosphor Material and Manufacturing Method of the Same

In the first implementation, as the green phosphor used in the green phosphor layer 35G, for example, Zn₂SiO₄:Mn is used. Zn₂SiO₄:Mn is prepared in the following method. Silicon dioxide (SiO₂), manganese compound such as manganese dioxide (MnO₂), and zinc oxide (ZnO) are mixed to match a combination of a desired phosphor material. The mixture is baked at least once at 1,100° C. to 1,300° C. in the air. Accordingly, the green phosphor material is prepared. Other than this, YAl₃(BO₄)₃:Tb, Y₃Al₅O₁₂:Ce, and the like may be used.

3-3. Red Phosphor Material and Manufacturing Method of the Same

The red phosphor material according to the first implementation is Y(Pₓ, V₁₋ₓ)O₄:Eu (hereinafter, referred to as YPV). The phosphorous element (P) and vanadium element (V) which are present in a crystal lattice of YPV may have different abundance ratios by a value of x. Here, the value of x is a value of the phosphorous element (P) with respect to a sum of the phosphorous element (P) and the vanadium element (V). The value of x is equal to or greater than “0” and equal to or less than 1. In the first implementation, the value of x of YPV is equal to or greater than 0.3 and equal to or less than 0.8.

The inventors of the instant application examined light emitting characteristics under ultraviolet excitation, especially afterglow characteristics, and PDP characteristics with respect to the YPV having different values of x as Eu³⁺ activated-red phosphor material. As a result, in a specific combination range, it was discovered that the value of x achieved high luminance, appropriate color purity, and a short afterglow time of 4.0 msec or less. Red light may be allowed even in the afterglow time which is relatively longer than that of green light having a long afterglow time, as image quality characteristics of a stereoscopic image display apparatus. Therefore, it is allowable that the afterglow time be 4.0 msec or less. It is preferable that the afterglow time be 3.5 msec or less, especially, 3.0 msec or less. The technology that has been disclosed here is based on the above described experiments.

Next, a manufacturing method of YPV according to the first implementation will be described. Yttrium oxide (Y₂O₃), diammonium hydrogen phosphate ((NH₄)₂HPO₄), vanadium oxide (V₂O₅), and europium oxide (Eu₂O₃) are weighed to match a combination of a desired phosphor material. These are mixed, and thereby a mixture is prepared. The mixture is baked at 1,100° C. in the air. As a result, the red phosphor material is prepared. Here, the value of x is determined by the molar ratio of diammonium hydrogen phosphate ((NH₄)₂HPO₄) and vanadium oxide (V₂O₅). It should be noted that the above method describes an exemplary method for manufacturing the YPV and other manufacturing methods of the YPV are possible.

3-4. Afterglow Time of Red Phosphor Material

The YPV according to the first implementation is an Eu³⁺ activated-red phosphor material. The YPV has a main light-emitting peak in a wavelength range of equal to or greater than 610 nm and less than 630 nm. Further, the YPV emits red light in which a maximum intensity of an orange emission component in a wavelength range of equal to or greater than 580 nm and less than 600 nm is equal to or greater than 2% and less than 20% of the main light-emission peak.

As for the emitting red light from the above described red phosphor material, it is preferable that the maximum intensity of the orange emission component on the same region is less than 20% of the main light-emitting peak in the same region. More preferably, the maximum intensity thereof is less than 15%, and further more preferably less than 13%. The Eu³⁺ activated-red phosphor material having the main light-emitting peak in the same region is different from (Y, Gd)BO₃:Eu³⁺ and the like having the main light-emitting peak in the vicinity of 590 nm. The red phosphor material has a large light-emitting component ratio based on electronic dipole transition of Eu³⁺ ion. Therefore, the red phosphor material emits red light of a relatively short afterglow of about 2 msec to 5 msec. The above described red light has a small orange light-emitting component ratio of a long afterglow of about 10 msec or greater based on magnetic dipole transition of Eu³⁺ ion. In addition, a red light-emitting component ratio of a short afterglow of about 2 msec to 5 msec is large based on the electronic dipole transition. Accordingly, it is preferable that the red light having short afterglow characteristics of about 4.0 msec or less be obtained.

Hereinafter, an afterglow time of YPV according to the first implementation will be described.

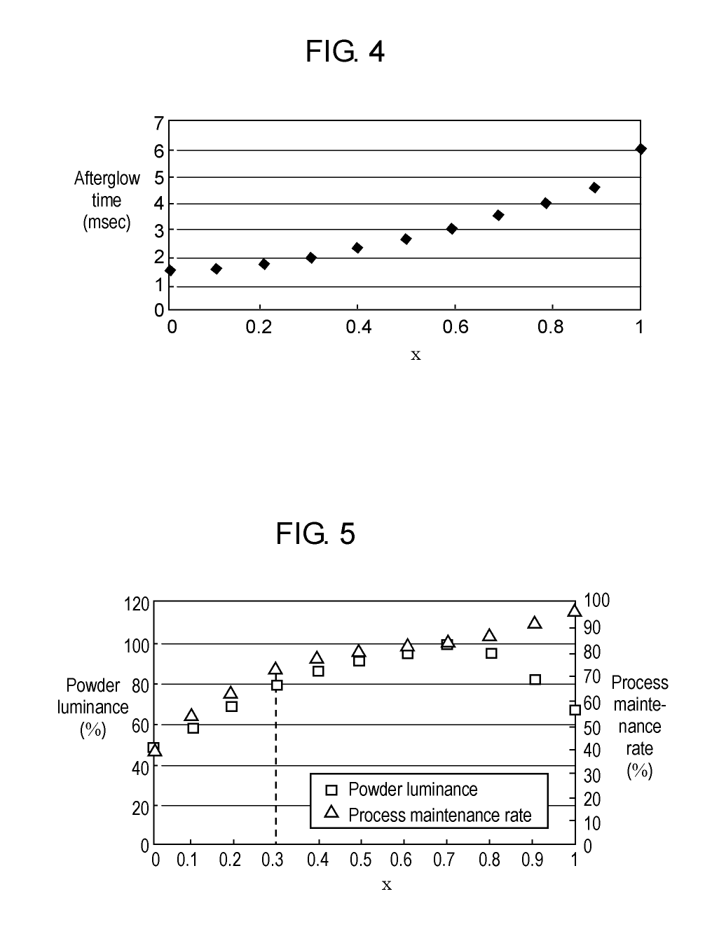

FIG. 4 is a view showing the relationship between a value of x of YPV according to a first implementation and an afterglow time of a plasma display apparatus. In the first implementation, afterglow characteristics of the plasma display apparatus using YPV when the value of x is 0, 0.1, 0.2, 0.3, 0.4, 0.5, 0.6, 0.7, 0.8, 0.9, and 1 have been verified. As shown in FIG. 4, it has been found that the afterglow time was increased along with an increase in the value of x, and the afterglow time was reduced along with a reduction in the value of x. It is preferable that the afterglow time of the red light according to the first implementation be equal to or less than 4.0 msec. Therefore, it has been found that the value of x of YPV was preferably equal to or less than 0.8. It has been found that the value of x may be equal to less than 0.7 to enable the afterglow time to be equal to or less than 3.5 msec. Further, the value of x is equal to or less than 0.6 to enable the afterglow time to be equal to or less than 3.0 msec.

As for the above described afterglow characteristics, in the plasma display apparatus according to the first implementation, when the value of x of YPV is equal to or less than 0.8, the afterglow time may be equal to or less than 4.0 msec. In addition, when the value of x of YPV is equal to or less than 0.6 in the plasma display apparatus, the afterglow time may be equal to or less than 3.0 msec.

3-5. Powder Luminance of YPV and Luminance of Panel

FIG. 5 is a view showing the relationship between powder luminance and a process maintenance rate with respect to a value of x of YPV according to the first implementation. The powder luminance of YPV is excited by an excimer lamp (a light source: krypton) having a wavelength of 146 nm under a vacuum such that luminance is obtained, and the light emission is measured and calculated using a spectrophotometer (C10027 manufactured by Hamamatsu Photonics). The YPV used here is formed by pressuring at 4 MPa using a former of a fixture and a mold having a predetermined opening area. A value of the powder luminance of YPV in each value of x shown in FIG. 5 is a relative value.

When the value of x is 0.7, the value of powder luminance is set as 100%. The process maintenance rate is a maintenance rate of luminance before and after the YPV passes through a manufacturing process of PDP. The process maintenance rate is calculated as below. The paste containing the phosphor material is coated on the rear plate 30 of the PDP, and a peak intensity of 618 nm in a light emission spectrum obtained when exciting the rear plate 30 having been baked, in the excimer lamp having a wavelength of 146 nm under a vacuum, is set as 100%. As for the peak intensity, the completed rear plate 30 of PDP 10 is cut out, and a value of the peak intensity obtained from the rear plate 30 in the same manner is relatively shown.

As shown in FIG. 5, it has been found that the powder luminance of YPV was increased as x approaches from 0 to 0.7. Meanwhile, it has been found that the powder luminance of YPV was reduced from the maximum value when x exceeds 0.7. In other words, it has been found that the powder luminance of YPV attains the maximum value when x is 0.7. In addition, it has been found that the process maintenance rate was increased along with an increase in the value of x. Meanwhile, it has been found that the process maintenance rate was reduced along with a reduction in the value of x. In particular, it has been found that the process maintenance rate was rapidly increased when the value of x becomes larger than 0.8. Meanwhile, it has been found that the process maintenance rate was rapidly reduced when the value of x becomes less than 0.3.

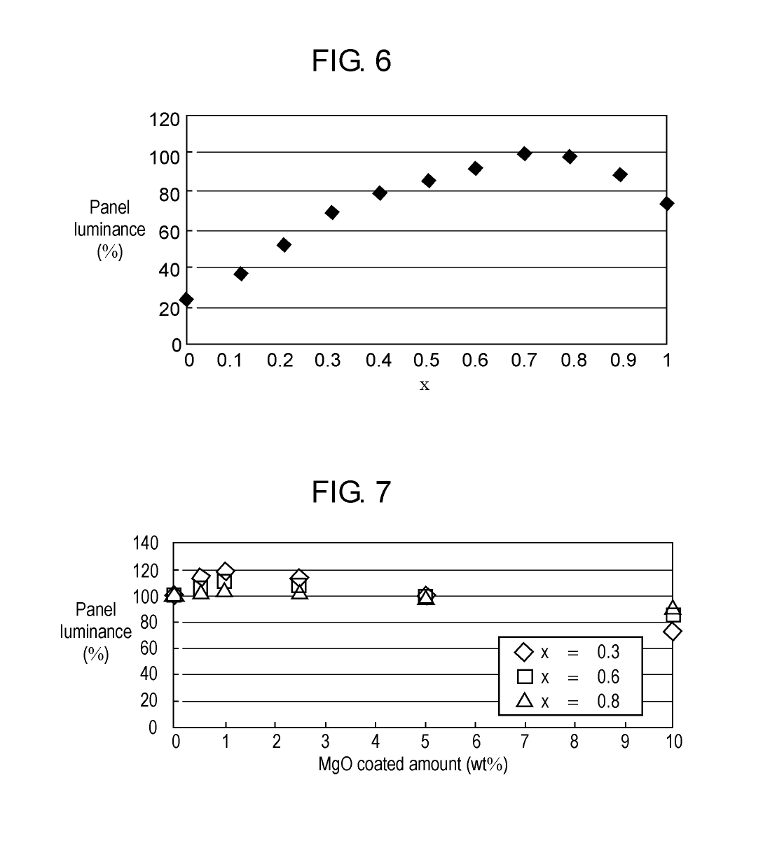

Next, panel luminance of YPV will be described. FIG. 6 is a view showing the relationship between a value of x of YPV and panel luminance according to the first implementation. The panel luminance of YPV is luminance obtained by measuring, using a luminance meter (CS-2000 manufactured by Konica Minolta), the quantity of light emission when only the red phosphor layer in the plasma display apparatus is made to emit light to thereby display a full screen as a red screen. A value of the panel luminance of YPV in the value of x shown in FIG. 6 is a relative value. When the value of x is 0.7, the value of the panel luminance is set as 100%.

As shown in FIG. 6, it has been found that the panel luminance of YPV was increased along with an increase in the value of x, and the panel luminance attains the maximum value when the value of x is 0.7. Meanwhile, it has been found that the panel luminance was significantly reduced when the value of x of YPV becomes less than 0.3. From the results of FIGS. 5 and 6, it has been found that the panel luminance had the relationship between the powder luminance and the process maintenance rate. Specifically, it has been found that, when multiplying a relative value of the powder luminance by a relative value of the process maintenance rate, the obtained value corresponded with a relative value of the panel luminance shown in FIG. 6. As shown in FIG. 5, since both the powder luminance and the process maintenance rate are increased as the value of x approaches 0.7 from 0, a value of multiplying the powder luminance by the process maintenance rate is also increased. In other words, the panel luminance is increased as the value of x approaches 0.7. Since the powder luminance when x is 0.7 attains the maximum value, the panel luminance also attains the maximum value. Meanwhile, when the value of x exceeds 0.7, the process maintenance rate is increased; however, the powder luminance is reduced, so that a value of multiplying the powder luminance by the process maintenance rate is reduced.

In other words, when the value of x exceeds 0.7, the panel luminance is reduced, and attains a value lower than the maximum panel luminance when the value of x is 0.7. In addition, when the value of x is less than 0.3, the powder luminance is gradually reduced along with a reduction in the value of x, and the process maintenance rate is rapidly reduced. As a result, a value of multiplying the powder luminance by the process maintenance rate is rapidly reduced. In other words, the panel luminance shown in FIG. 6 is also rapidly reduced when the value of x is less than 0.3.

Accordingly, it has been found that the relationship between the powder luminance and the panel luminance was related to the process maintenance rate, so that a value of multiplying the relative value of the powder luminance by the relative value of the process maintenance rate corresponded to the relative value of the panel luminance.

As described above, when considering the process maintenance rate, when the value of x is equal to or greater than 0.3, process maintenance of YPV is good even after the manufacturing process, and it is possible to provide the high quality PDP apparatus having high panel luminance. In addition, when considering the afterglow time, it is preferable that the value of x be equal to or less than 0.8. It may be more preferable that the value of x be equal to or less than 0.6. Therefore, it is preferable that the value of x of YPV be equal to or greater than 0.3 and equal to or less than 0.8.

Accordingly, it is possible to provide the plasma display apparatus having good process maintenance rate and high luminance in the afterglow time equal to or less than 4.0 msec. Specifically, when the value of x of YPV is equal to or greater than 0.3 and equal to or less than 0.6, the afterglow time is equal to or less than 3.0 msec. Furthermore, when the value of x of YPV is equal to or greater than 0.6 and equal to or less than 0.8, higher luminance may be maintained.

### Second Implementation

Next, a second implementation will be described. For the sake of brevity, descriptions of the same content as those of the first implementation will be omitted.

4-1. Red Phosphor Material

A plasma display apparatus according to a second implementation includes a red phosphor layer 35R that is formed using a red phosphor material containing YPV on which magnesium oxide (hereinafter, referred to as MgO) is coated.

4-2. Manufacturing Method of Red Phosphor Material

First, a method of coating a surface of YPV according to the first implementation with MgO will be described. Magnesium nitrate (Mg (NO₃)₂) was dissolved into water or an alkali aqueous solution in a concentration of a predetermined amount. YPV (an average particle diameter D50=3.6 μm) was fed into the dissolving solution to prepare a mixture solution, and the mixture solution was further stirred. Thereafter, the mixture solution was filtered, and then YPV remaining on a filter paper was washed. Thereafter, YPV was dried at 150° C. The dried YPV was baked at 400° C. to 800° C. under an air, to prepare YPV with MgO coated on a surface thereof. The MgO may be evenly coated on the surface of YPV to prevent the exposure of the surface of YPV.

The above describes one method of coating the surface of YPV with MgO; however, it should be noted that a method of coating the surface of the YPV with MgO is not limited thereto and other methods are possible.

4-3. Relationship Between Panel Luminance and Coated Amount of MgO

Next, a relationship between the panel luminance of the plasma display apparatus including the red phosphor layer 35R that is formed using the red phosphor material containing YPV with MgO coated thereon will be described. FIG. 7 is a view showing the relationship between a coated amount of MgO of YPV and panel luminance. Here, the panel luminance of YPV when x=0.3, x=0.6, and x=0.8 are satisfied was measured. The panel luminance in each value of x is shown as a relative value when panel luminance of YPV on which MgO is not coated is set as 100%. In addition, here, the coated amount of MgO shows a weight ratio of YPV to MgO in the mixture solution. This is because a coated amount of MgO, for example, when MgO is 5 g relative to 100 g of YPV in the mixture solution is approximated almost to 5 wt % in a weight ratio to YPV. The panel luminance in each value of x was measured using YPV when the coated amount of MgO is 0.5 wt %, 1.0 wt %, 2.5 wt %, 5.0 wt %, and 10.0 wt %.

As shown in FIG. 7, it has been found that, in each value of x, the panel luminance was increased along with an increase in the coated amount of MgO in comparison with the panel luminance in which the coated amount of MgO was 0 wt %. Here, as for the panel luminance, it has been expected that the panel luminance when the coated amount of MgO is 1 wt % attains the maximum value. This has been considered to be due to improvement of the process maintenance rate by coating the surface of YPV with MgO. When x is 0.3, the reason why the improvement of the panel luminance is the largest in comparison with YPV on which MgO is not coated is because YPV on which MgO is not coated when x is 0.3, has a lower process maintenance rate in comparison with when the value of x is larger than 0.3, however, has a large absolute value of luminance capable of being improved by coating MgO. Meanwhile, when x is 0.8, the reason why the improvement of the panel luminance is the smallest in comparison with YPV on which MgO is not coated is because YPV on which MgO is not coated when x is 0.8 has a higher process maintenance rate in comparison with when x is less than 0.8, and a small absolute value of luminance capable of being improved by coating YPV with MgO.

In addition, it has been expected that, when the coated amount of MgO is larger than 1 wt %, the panel luminance is gradually reduced. When the coated amount of MgO is 5 wt %, the same panel luminance as that in the case of YPV on which MgO is not coated is shown. Further, when the coated amount of MgO exceeds 5 wt %, the panel luminance is smaller than that in the case of YPV on which MgO is not coated. This has been considered that the effect of a luminance reduction of a powder of YPV due to the coating of MgO becomes large with respect to the fact that the process maintenance rate is saturated along with an increase of the coated amount of MgO.

To summarize the above, the second implementation describes a panel having higher luminance than that of YPV on which MgO is not coated in a range in which the coated amount of MgO is greater than 0 wt % and less than 5 wt % may be obtained.

### Third Implementation

Next, a third implementation will be described. For the sake of brevity, descriptions of the same content as those of the first implementation will be omitted.

5-1. Red Phosphor Material

A plasma display apparatus according to a third implementation includes a red phosphor layer 35R that is formed using a red phosphor material containing YPV on which zinc oxide (hereinafter, referred to as ZnO) is coated.

5-2. Manufacturing Method of Red Phosphor Material

First, a method of coating a surface of YPV according to the first implementation with ZnO will be described. Zinc nitrate (Zn(NO₃)₂) was dissolved into water or an alkali aqueous solution in a concentration of a predetermined amount. YPV (an average particle diameter D50=3.6 μm) was fed into the dissolving solution to prepare a mixture solution, and the mixture solution was further stirred. Thereafter, the mixture solution was filtered, and then YPV remaining on a filter paper was washed. Thereafter, YPV was dried at 150° C. The dried YPV was baked at 400° C. to 800° C. under an air, so that YPV with ZnO coated on a surface thereof was manufactured. The ZnO may be evenly coated on the surface of YPV to prevent the exposure of the surface of YPV.

The above describes one method of coating the surface of YPV with ZnO; however, it should be noted that a method of coating the surface of the YPV with ZnO is not limited thereto and other methods are possible.

5-3. Relationship Between Panel Luminance and Coated Amount of ZnO

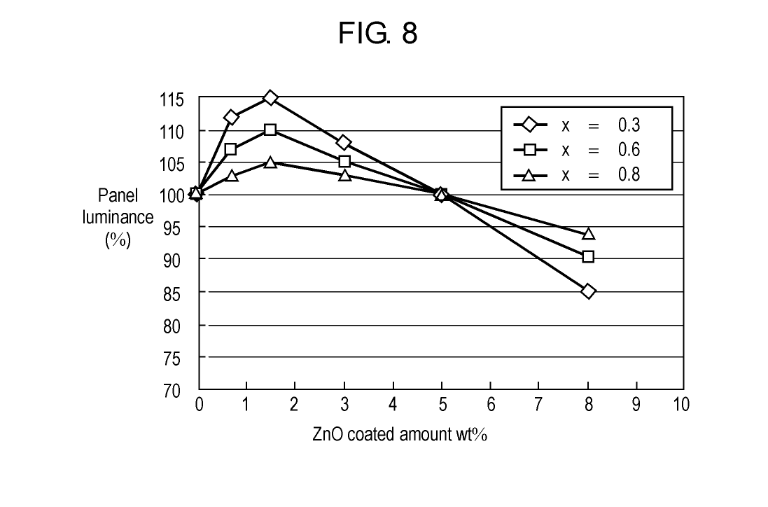

Next, a relationship between the panel luminance of the plasma display apparatus including the red phosphor layer 35R that is formed using the red phosphor material containing YPV with ZnO coated thereon will be described. FIG. 8 is a view showing the relationship between a coated amount of ZnO in YPV and panel luminance. Here, the panel luminance of YPV when x=0.3, x=0.6, and x=0.8 are satisfied was measured. The panel luminance in each value of x is shown as a relative value when panel luminance of YPV on which ZnO is not coated is set as 100%. In addition, here, the coated amount of ZnO shows a weight ratio of YPV to ZnO in the mixture solution. This is because a coated amount of ZnO, for example, when ZnO is 5 g relative to 100 g of YPV in the mixture solution is approximated almost to 5 wt % in a weight ratio to YPV. The panel luminance in each value of x was measured using YPV when the coated amount of ZnO is 0.5 wt %, 1.5 wt %, 3.0 wt %, 5.0 wt %, and 8.0 wt %.

As shown in FIG. 8, it has been found that, in each value of x, the panel luminance was increased along with an increase in the coated amount of ZnO in comparison with the panel luminance in which the coated amount of ZnO was 0 wt %. Here, as for the panel luminance, it has been expected that the panel luminance when the coated amount of ZnO is 1.5 wt % attains the maximum value. This has been considered to be due to improvement of the process maintenance rate by coating the surface of YPV with ZnO. When x is 0.3, the reason why the improvement of the panel luminance is the largest in comparison with YPV on which ZnO is not coated is because YPV on which ZnO is not coated when x is 0.3, has a lower process maintenance rate in comparison with when the value of x is larger than 0.3, however, has a large absolute value of luminance capable of being improved by coating ZnO. Meanwhile, when x is 0.8, the reason why the improvement of the panel luminance is the smallest in comparison with YPV on which ZnO is not coated is because YPV on which ZnO is not coated when x is 0.8 has a higher process maintenance rate in comparison with when x is less than 0.8, and a small absolute value of luminance capable of being improved by coating YPV with ZnO.

In addition, it has been expected that, when the coated amount of ZnO is larger than 1.5 wt %, the panel luminance is gradually reduced. When the coated amount of ZnO is 5 wt %, the same panel luminance as that in the case of YPV on which ZnO is not coated is shown. Further, when the coated amount of ZnO exceeds 5 wt %, the panel luminance is smaller than that in the case of YPV on which ZnO is not coated. This has been considered that the effect of a luminance reduction of a powder of YPV due to the coating of ZnO becomes large with respect to the fact that the process maintenance rate is saturated along with an increase of the coated amount of ZnO. In addition, in the exemplary implementation of the above described YPV on which MgO is coated, the effect of an increase of the panel luminance when the coated amount of ZnO is 1.5 wt % in YPV on which ZnO is coated becomes the maximum with respect to the fact that the effect of an increase of the panel luminance when the coated amount of MgO is 1.0 wt %. This is because a crystal density of MgO is 3.58 g/cm³, whereas a crystal density of ZnO is 5.64 g/cm.³ To this end, the crystal density of ZnO is 1.5 times the crystal density of MgO. As a result, when the surface of YPV is coated in the same area as a coated area by MgO, ZnO requires 1.5 times a mass of MgO.

To summarize the above, the third implementation describes a panel having higher luminance than that of YPV on which ZnO is not coated in a range in which the coated amount of ZnO is greater than 0 wt % and less than 5 wt % may be obtained.

### Fourth Implementation

Next, a fourth implementation will be described. For the sake of brevity, the descriptions of the same content as those of the first implementation will be omitted.

6-1. Red Phosphor Material

A plasma display apparatus according to a fourth implementation includes a red phosphor layer 35R that is formed using a red phosphor material containing YPV on which silicon dioxide (hereinafter, referred to as SiO₂) is coated. In the fourth implementation, as the red phosphor layer, YPV of x=0.7 (as the red phosphor material containing Y(P_{0.7}V_{0.3})O₄:Eu in which the value of x is equal to or less than 0.8) is used.

6-2. Manufacturing Method of Red Phosphor Material

First, a method of coating the surface of YPV according to the first implementation with SiO₂ will be described. YPV (an average particle diameter D50=3.6 μm) was fed into water to prepare a mixture solution. The mixture solution was stirred to prepare a suspension of YPV. Sodium silicate (Na₂SiO₃) of a predetermined amount was added to the suspension. Acid such as hydrochloric acid (HCI) was gradually added to the suspension while the suspension was maintained at a high temperature of 70° C. or above. The suspension may be neutral or have a mild acidity. Due to this, silica was evenly deposited on the surface of YPV at high density. The suspension was filtered, and YPV remaining on a filter paper was washed. Thereafter, YPV was dried at 150° C. The dried YPV was baked at 400° C. to 800° C. under an air to prepare YPV with SiO₂ coated on a surface thereof. The SiO₂ may be evenly coated on the surface of YPV to prevent the exposure of the surface of YPV.

The above describes one method of coating the surface of YPV with SiO₂; however, it should be noted that a method of coating the surface of the YPV with SiO₂ is not limited thereto and other methods are possible.

6-3. Relationship Between Coated Amount of SiO₂ and Powder Luminance

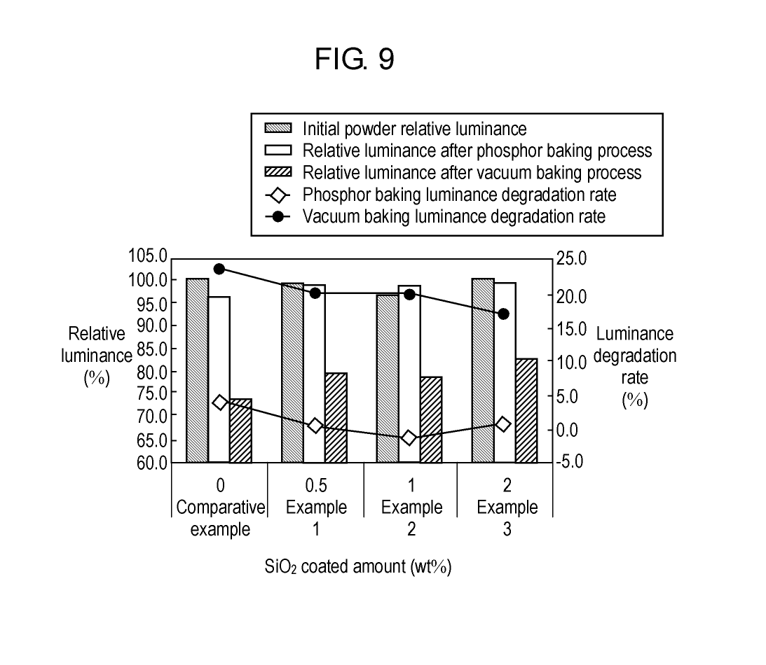

Next, powder luminance of YPV and a process luminance degradation rate will be described. FIG. 9 is a view showing the relationship between relative luminance and a luminance degradation rate with respect to a coated amount of SiO₂ of YPV. A bar graph shows the relationship between a coated amount of SiO₂ and relative luminance (%) in each process which will be described later (a left vertical axis). A curved line graph shows the relationship between the coated amount of SiO₂ and a process luminance degradation rate (%) which is changed between respective processes which will be described later (right vertical axis). In addition, here, the coated amount of SiO₂ shows a weight ratio of YPV to SiO₂ in the mixture solution. This is because a coated amount of SiO₂, for example, when SiO₂ is 5 g relative to 100 g of YPV in the mixture solution is approximated almost to 5 wt % in a weight ratio to YPV.

The relative luminance in each process is defined as below. An initial powder relative luminance before performing a phosphor baking process corresponds to luminance of a phosphor powder before a phosphor paste preparing process. The relative luminance after the process of baking the phosphor corresponds to luminance of a phosphor after a process of baking a phosphor paste in a panel production process. The relative luminance after a vacuum baking process of the phosphor corresponds to equivalent luminance to the phosphor after an airtight sealing process in the panel production process. Further, the initial powder luminance of YPV shown in FIG. 9 is defined as below. The initial powder luminance is luminance obtained by exciting YPV formed by pressuring at 4 MPa in the excimer lamp (a light source: krypton) having a wavelength of 146 nm under a vacuum using a former of a fixture and a mold having a predetermined opening area, and measuring and calculating the light emission using a spectrophotometer (C10027 manufactured by Hamamatsu Photonics). The relative luminance shown in FIG. 9 sets initial powder luminance of a case in which SiO₂ is not coated as 100%, and relatively shows luminance of a phosphor in each coated amount.

The process luminance degradation rate that is changed between respective processes is defined as below. A phosphor baking luminance degradation rate shows the changing rate of the relative luminance before and after the baking process of the phosphor. The vacuum baking luminance degradation rate shows the changing rate of the relative luminance before and after the vacuum baking process. The process luminance degradation rate sets the relative luminance in the previous process as 100%. For example, the phosphor baking luminance degradation rate shows the changing rate (%) toward the relative luminance after the baking process of the phosphor from the relative luminance of an initial powder. The vacuum baking degradation rate shows the changing rate (%) toward the relative luminance after the vacuum baking from the relative luminance after the phosphor baking. The process luminance degradation rate corresponds to 0% when the relative luminance before and after the process is not changed, and shows a positive value when the luminance is degraded. For example, the luminance degradation rate in the phosphor baking process shows the changing rate toward the relative luminance after the phosphor baking process from the initial powder relative luminance. The degradation rate after the vacuum baking process shows the changing rate toward the relative luminance after the vacuum baking from the relative luminance after the phosphor baking.

6-4. Experimental Results

From FIG. 9, a process luminance degradation rate of the phosphor baking process and the vacuum baking process is reduced by coating YPV with SiO₂, and the relative luminance after the vacuum baking is increased.

6-4-1. Comparative Example

In the comparative example, the relative luminance of YPV on which SiO₂ is not coated and a luminance degradation rate are shown. With respect to the fact that an initial powder relative luminance of YPV on which SiO₂ is not coated is 100%, luminance after the phosphor baking process is 96.1%, resulting in 3.9% luminance degradation. Further, by vacuum-baking YPV on which SiO₂ is not coated, the vacuum baking relative luminance is 73.7%, resulting in 23.4% luminance degradation due to the vacuum-baking.

6-4-2. Example 1

In the example 1, the relative luminance of YPV on which SiO₂ is coated in an amount of 0.5 wt % and a luminance degradation rate are shown. With respect to the fact that an initial powder relative luminance of YPV on which SiO₂ is coated in an amount of 0.5 wt % is 99.4%, luminance after the phosphor baking process is 98.8% to obtain the luminance degradation rate of 0.6%. Further, by vacuum-baking YPV, the vacuum baking relative luminance is 79.4%, and luminance degradation of 19.4% occurs, so that luminance degradation suppression effect of 3.7% is seen in comparison with the relative luminance after vacuum-baking YPV on which SiO₂ is not coated.

6-4-3. Example 2

In the example 2, the relative luminance of YPV on which SiO₂ is coated in an amount of 1.0 wt % and a luminance degradation rate are shown. With respect to the fact that an initial powder relative luminance of YPV on which SiO₂ is coated in an amount of 1.0 wt % is 97.5%, luminance after the phosphor baking process is 98.6% so that luminance recovery of 1.1% is seen. Further, by vacuum-baking YPV, the vacuum baking relative luminance is 79.0%, and luminance degradation of 19.6% occurs, so that luminance degradation suppression effect of 3.5% is seen in comparison with the relative luminance after vacuum-baking YPV on which SiO₂ is not coated.

6-4-4. Example 3

In the example 3, the relative luminance of YPV on which SiO₂ is coated in an amount of 2.0 wt % and a luminance degradation rate are shown. With respect to the fact that an initial powder relative luminance of YPV on which SiO₂ is coated in an amount of 2.0 wt % is 99.5%, luminance after the phosphor baking process is 98.6% so that luminance degradation of 0.9% is seen. Further, by vacuum-baking YPV, the vacuum baking relative luminance is 83.0%, and luminance degradation of 15.6% occurs, so that luminance degradation suppression effect of 7.8% is seen in comparison with the relative luminance after vacuum-baking YPV on which SiO₂ is not coated.

6-5 Conclusion

YPV is coated with SiO₂, so that the vacuum baking luminance degradation rate of YPV is reduced. The relative luminance after the vacuum baking process is also improved. Therefore, the luminance degradation in the panel production process is suppressed, resulting in improvement of panel luminance. In addition, even in YPV according to the fourth implementation, YPV having the same average particle diameter is used, so that the fourth implementation may have the same results as those of the second and third implementations. In other words, similar to the second and third implementations, when the coated amount of SiO₂ exceeds 5 wt %, corresponding panel luminance becomes smaller than the panel luminance of the case of YPV on which SiO₂ is not coated. This has been considered that the effect of a luminance reduction of a powder of YPV due to the coating of SiO₂ becomes large with respect to the fact that the process maintenance rate is saturated along with an increase in the coated amount of SiO₂.

Accordingly, it is preferable that the coated amount of SiO₂ be larger than 0 wt % and less than 5.0 wt %.

The red phosphor material may be excellent in red color purity by changing the type or the composition of the phosphor, or the like. However, the red phosphor material may have a problem in that luminance is reduced when trying to obtain red light of short afterglow. The technology disclosed herein solves the above described problems, and provides a red phosphor material which reduces an afterglow time while suppressing a reduction in luminance. In order to solve the above problems, technology disclosed herein has the following features.

(1) The red phosphor material of the technology disclosed here includes Y(Pₓ, V₁₋ₓ)O₄:Eu (where, a value of x is equal to or greater than 0.3 and equal to or less than 0.8). As a result, the red phosphor material can reduce the afterglow time while suppressing a reduction in luminance.

(2) As for the red phosphor material described in (1), it is preferable that the value of x be equal to or greater than 0.3 and equal to or less than 0.6. Due to this, it is possible to further suppress YPV from being degraded in short afterglow and in the course of the baking process.

(3) As for the red phosphor material described in (1), it is preferable that the value of x be equal to or greater than 0.6 and equal to or less than 0.8. Due to this, it is possible to provide the red phosphor material having higher luminance in the afterglow time equal to or less than 4.0 msec.

(4) As for the red phosphor material described in any one of (1) to (3), it is preferable that a surface of Y(Pₓ, V₁₋ₓ)O₄:Eu is coated with at least one metal oxide selected from the group consisting of magnesium oxide, zinc oxide, and silicon dioxide, and a weight % concentration of the metal oxide with respect to Y(Pₓ, V₁₋ₓ)O₄:Eu is greater than 0 wt % and less than 5 wt %. Due to this, it is possible to suppress YPV from being degraded in the course of the baking process.

(5) In the PDP including the red phosphor layer, the red phosphor layer is formed using the red phosphor material described in (1). Due to this, it is possible to provide PDP which reduces the afterglow time while suppressing the reduction of luminance.

(6) In the plasma display panel including the red phosphor layer, it is preferable that the red phosphor layer be formed using the red phosphor material described in any one of (2) and (3). Due to this, it is possible to achieve a PDP having the short afterglow equal to or less than 4.0 msec. Further, it is possible to provide a PDP which suppresses the phosphor from being degraded in the short afterglow equal to or less than 3.0 msec and in the course of the baking process. In addition, it is possible to provide a PDP having high luminance during the afterglow time equal to or less than 4.0 msec. As a result, it is possible to achieve the high-quality plasma display apparatus which has high luminance and suppresses crosstalk.

(7) In a PDP including the red phosphor layer, the red phosphor layer is formed using the red phosphor material described in (4). Due to this, it is possible to provide a PDP which further suppresses YPV from being degraded in the course of the baking process.

One of ordinary skill in the art recognizes that the technology disclosed herein is not limited to the above-described features. Other implementations are contemplated. For example, in the second to fourth implementations, the red phosphor in which the surface of Y(Pₓ, V₁₋ₓ)O₄:Eu is coated with MgO, ZnO, or SiO₂ has been described. However, the red phosphor may be coated with other materials such as, for example, strontium carbonate (SrCO₃), calcium carbonate (CaCO₃), barium carbonate (BaCO₃), or diphosphorus pentoxide (V₂O₅). In particular, when strontium carbonate (SrCO₃) or barium carbonate (BaCO₃) is coated, the process maintenance rate may be good.

The plasma display apparatus based on the teachings of the instant application can have short afterglow characteristics and can enable high luminance and high color gamut display. To this end, teachings of the instant application can be useful in a high fineness image display apparatus, a stereoscopic image display apparatus, and the like.

What is claimed is:

1. A red phosphor material including Y(Pₓ, V₁₋ₓ)O₄:Eu, wherein a value of x is equal to or greater than 0.3 and equal to or less than 0.8.

2. The red phosphor material of claim 1, wherein the value of x is equal to or greater than 0.3 and equal to or less than 0.6.

3. The red phosphor material of claim 1, wherein the value of x is equal to or greater than 0.6 and equal to or less than 0.8.

4. The red phosphor material of any one of claims 1 to 3, wherein:
a surface of the Y(Pₓ, V₁₋ₓ)O₄:Eu is coated with at least one metal oxide selected from the group consisting of magnesium oxide, zinc oxide, and silicon dioxide, and
a weight % concentration of the metal oxide with respect to the Y(Pₓ, V₁₋ₓ)O₄:Eu is greater than 0 wt % and less than 5 wt %.

5. A plasma display panel including a red phosphor layer, wherein the red phosphor layer is formed of the red phosphor material of claim 1.

6. A plasma display panel including a red phosphor layer, wherein the red phosphor layer is formed of the red phosphor material of any one of claims 2 and 3.

7. A plasma display panel including a red phosphor layer, wherein the red phosphor layer is formed of the red phosphor material of claim 4.
